(19) United States
(12) Patent Application Publication
(10) Pub. No.: US 2012/0072270 A1
(43) Pub. Date: Mar. 22, 2012

(54) Ad Wallet

(76) Inventors: Dan Waylonis, Mountain View, CA (US); Anita Krishnakumar, Santa Clara, CA (US); Ping Wu, Saratoga, CA (US)

(21) Appl. No.: 12/886,928

(22) Filed: Sep. 21, 2010

(51) Int. Cl. G06Q 30/00; G06F 17/30

(52) U.S. Cl. 705/14.1; 705/14.4; 707/610; 707/E17.005

(57) ABSTRACT

In general, this specification relates to content presentation. In general, one aspect of the subject matter described in this specification can be embodied in methods that include the actions of presenting a first content item to a first device associated with a user; receive a input from the first device indicating that the first content item has been stored in a repository of the first device; in response to the input, synchronizing the repository of the first device with a user account including the first content item; receiving a request for one or more content items stored in the user account from a second device associated with the user; presenting the requested content items on the second device associated with the user including the first content item; and receiving an indication of a conversion event associated with the presented first content item on the second device.

### BACKGROUND

The present disclosure relates to content presentation.

Advertisers provide advertisements in different forms in order to attract consumers. Ads can be provided in electronic form. For example, online ads can be provided as banner ads on a web page, as ads presented with search results, or as ads presented in a mobile application.

### SUMMARY

In general, this specification relates to content presentation.

In general, one aspect of the subject matter described in this specification can be embodied in methods that include the actions of presenting a first content item to a first device associated with a user; receive a input from the first device indicating that the first content item has been stored in a repository of the first device; in response to the input, synchronizing the repository of the first device with a user account including the first content item; receiving a request for one or more content items stored in the user account from a second device associated with the user; presenting the requested content items on the second device associated with the user including the first content item receiving an indication of a conversion event associated with the presented first content item on the second device; and logging the conversion event. Other embodiments of this aspect include corresponding systems, apparatus, and computer program products.

These and other embodiments can optionally include one or more of the following features. The first content item is an advertisement. The method further includes crediting an account associated with the user in response to the conversion event. Crediting includes awarding points that can be redeemed for one or more products or services. Crediting includes providing one or more discounts. The method further includes providing interaction between the user of the second device and the contents of the user account including presenting a user interface for viewing content items synchronized to the user account. Presenting the requested content items includes presenting redemption location information associated with each presented content item. The method further includes receiving a user request that a content item stored on the user device be shared with a second user; and sending the content item to an account of the second user.

The systems and techniques described here can provide one or more of the following advantages. Ads presented to a user on a mobile device can be saved and shown to the same user at a later time or on a different device. Ads can be shared between users. Incentives can be provided to users to save or interact with ads. Ad conversions associated with a single user can be tracked across multiple devices. Additionally, the ability to save ads provides a user with an option to save an ad for later use or interaction. For example, if the user is presented with an interesting ad but did not have time (or using the desired display device, e.g., a large monitor) to follow-up immediately (e.g., by selecting the ad), the user can save the ad for perusing later or on a bigger screen, etc.

The details of one or more implementations are set forth in the accompanying drawings and the description below. Other features and advantages will be apparent from the description and drawings, and from the claims.

### DESCRIPTION OF DRAWINGS

FIG. 1 is a diagram of an example content presentation system.

FIG. 2 is a block diagram of an example system for providing an ad wallet.

FIG. 3 is a flow diagram of an example process for using an ad wallet.

FIG. 4 is a flow diagram of an example process for using an ad wallet.

FIG. 5 shows an example of a computing device and a mobile computing device.

Like reference symbols in the various drawings indicate like elements.

### DETAILED DESCRIPTION

In some examples, a content item displayed to a user can be saved to a user device, synchronized with a remote server, and displayed on another user device for the same or a different user. The user can save a content item for later interactions on the same device it was originally shown on, or on another device. Content items saved by the user can be shared with other users. An incentive system can reward the user for interacting with a content item, or for sharing the content item with another user.

While reference will be made below to advertising systems and methods, other forms of content items including other forms of sponsored content can be managed, presented, and tracked in accordance with the description below.

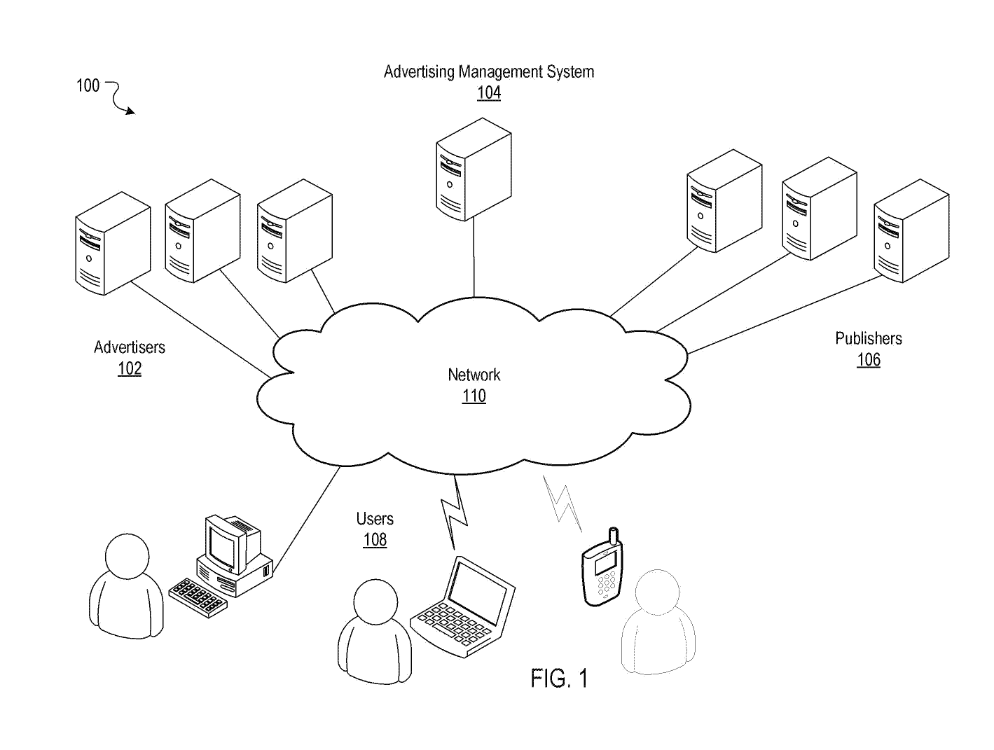

FIG. 1 is a block diagram of an example content presentation system 100. In some implementations, one or more advertisers 102 can directly, or indirectly, enter, maintain, and track ad information in an advertising management system 104. Though reference is made to advertising, other forms of content, including other forms of sponsored content, can be delivered by the system 100. The ads can be in the form of graphical ads, such as banner ads, text only ads, image ads, barcode ads (e.g., ads including one or more barcodes for use in redeeming the ad), audio ads, video ads, animated ads, ads combining one or more of any of such components, etc. The ads can also include embedded information, such as links, meta-information, and/or machine executable instructions.

One or more publishers 106 can submit requests for ads to the system 104. The system 104 responds by sending ads to the requesting publisher 106 for placement on or association with one or more of the publisher's content items (e.g., web properties). Example web properties can include web pages, television and radio advertising slots, or print media space.

Other entities, such as users 108 and the advertisers 102, can provide usage information to the system 104, for example, whether or not a conversion (e.g., a purchase or other interaction) or a click-through related to an ad (e.g., a user has selected an ad) has occurred. This usage information can include measured or observed user behavior related to ads that have been served. The system 104 may perform financial transactions, for example, crediting the publishers 106 and charging the advertisers 102 based on the usage information.

A network 110, such as a local area network (LAN), wide area network (WAN), the Internet, one or more telephony networks or a combination thereof, connects the advertisers 102, the system 104, the publishers 106, and the users 108.

One example publisher 106 is a general content server that receives requests for content (e.g., articles, discussion threads, music, video, graphics, search results, web page listings, information feeds, etc.), and retrieves the requested content in response to the request. The content server can submit a request for ads to an advertisement server in the system 104. The ad request can include a number of ads desired. The ad request can also include content request information. This information can include the content itself (e.g., page, video broadcast, radio show, or other type of content), a category corresponding to the content or the content request (e.g., arts, business, computers, arts-movies, arts-music, etc.), part or all of the content request, content age, content type (e.g., text, graphics, video, audio, mixed media, etc.), geo-location information, etc.

In some implementations, the content server or a client browser combines the requested content with one or more of the ads provided by the system 104. The combined content and ads can be sent/rendered to the users 108 that requested the content for presentation in a viewer (e.g., a browser or other content display system). Alternatively, in some implementations, content and ads are sent separately to the users 108 (e.g., received content can include code for requesting ads when rendered by a browser or other application or ads can be incorporated in content as received from an ad system). The content server can transmit information about the ads back to the advertisement server, including information describing how, when, and/or where the ads are to be rendered (e.g., in HTML or JavaScript™).

Another example publisher 106 is a search service. A search service can receive queries for search results. In response, the search service can retrieve relevant search results from an index of documents (e.g., from an index of web pages). Search results can include, for example, lists of web page titles, snippets of text extracted from those web pages, and hypertext links to those web pages, and may be grouped into a predetermined number of (e.g., ten) search results.

The search service can submit a request for ads to the system 104. The request may include a number of ads desired. This number can depend, for example, on the search results, the amount of screen or page space occupied by the search results, the size and shape of the ads, etc. The request for ads may also include the query (as entered or parsed), information based on the query (such as geo-location information, whether the query came from an affiliate and an identifier of such an affiliate), and/or information associated with, or based on, the search results. Such information can include, for example, identifiers related to the search results (e.g., document identifiers or “docIDs”), scores related to the search results (e.g., information retrieval (“IR”) scores), snippets of text extracted from identified documents (e.g., web pages), full text of identified documents, feature vectors of identified documents, etc. In some implementations, IR scores are computed from, for example, dot products of feature vectors corresponding to a query and a document, page rank scores, and/or combinations of IR scores and page rank scores, etc.

In some implementations, the advertisement management system 104 uses an auction process to select ads from the advertisers 102. For example, the advertisers 102 may be permitted to select, or bid, an amount the advertisers are willing to pay for each presentation of or interaction with (e.g., click) of an ad, e.g., a cost-per-click amount an advertiser pays when, for example, a user clicks on an ad. The cost-per-click can include a maximum cost-per-click, e.g., the maximum amount the advertiser is willing to pay for each click of an ad based on a keyword, e.g., a word or words in a query. Other bid types, however, can also be used. Based on these bids, ads can be selected and ranked for presentation.

The search service can combine the search results with one or more of the ads provided by the system 104. This combined information can then be forwarded to the users 108 that requested the content. The search results can be maintained as distinct from the ads, so as not to confuse the user between paid ads and presumably neutral search results.

In some implementations, one or more publishers 106 submit requests for ads to the advertising management system 104. The system 104 responds by sending ads to the requesting publisher 106 for placement on one or more of the publisher's web properties (e.g., websites and other network-distributed content) that are relevant to the web property. For example, if a publisher 106 publishes a sports-related web site, the advertising management system can provide sports-related ads to the publisher 106.

In some other implementations, the requests are executed by devices associated with the user 108, e.g., by the execution of a script when the publishers web page is loading on a client device. For example, a loading web page can include scripts to request one or more ads for placement within the rendered web page. The browser or other application can send an ad request in response and incorporate received ads into the web page.

Another example publisher 106 is a mobile application developer. A mobile application is an application specifically designed for operation on a mobile device (e.g., a smart phone). The mobile application can also include ads positioned within the content of the mobile application. Similar to publishers 106 described above, the ads can be received from the system 104 for placement in the mobile application when accessed by a user (e.g., when a particular page of a mobile application is loaded on the mobile device).

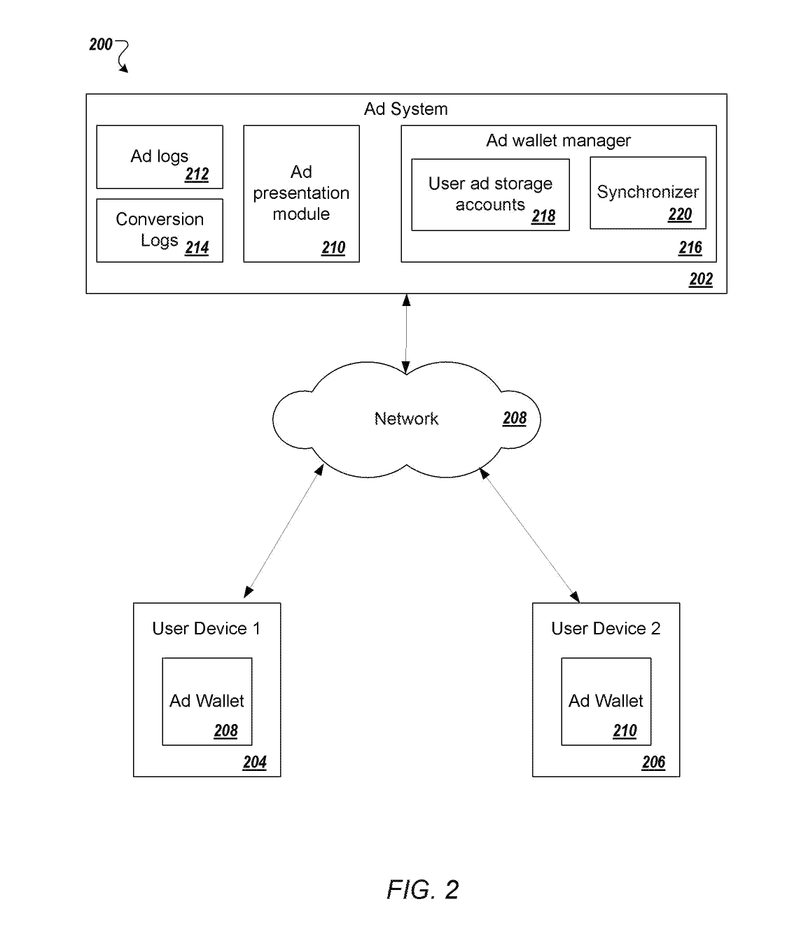

FIG. 2 is a block diagram 200 of an example system for providing an ad wallet. The ad wallet includes a repository or other ad storage. The ad wallet can also include features for interacting, organizing, and sharing ads in the ad wallet (e.g., as an application or browser user interface with an ad system for accessing the ad wallet).

The system 200 includes an ad system 202, user devices 204 and 206, and a network 208. The user devices 204 and 206 can display ads and add them to an ad wallet associated with a user.

Content presented on the user devices 204 and 206 to the user can include one or more ads. For example, web pages, search results, and application content can include slots for ads to be presented along with the content. The ads can be presented in different ways. For example, a publisher or other content provider can provide both content and ads in response to a request from a user device. When a request for content is received by the content provider, the content provider can send a request for one or more ads to the ad system 202. Received ads can be integrated into the content prior to providing the content to the particular user device for display.

In some other implementations, a user device requests content from the ad system 202 directly. For example, received content can include scripting or other instructions such that when the content is rendered for display the instructions are executed to request one or more ads from the ad system 202. Received ads are then integrated into the content either prior to display or as they are received. In another example, an ad request can be sent to the ad system 202 along with a content request to the particular content provider. The received ads can be incorporated with the content at the user device. The request can be sent to the ad system 202 by the user device by an application on the user device (e.g., browser or other application) directly or through an API.

In some implementations, a request for content is sent, e.g., to a content provider, which then sends an ad request to the ad system 202. However, the ad system 202 then sends ads directly to the user device rather than to the content provider for integration with the content.

The ad system 202 can contain components for storing, recording, and presenting ads. An ad presentation module 210 can select ads for presentation on user devices. Ad logs 212 and conversion logs 214 can store presentation and conversion events, respectively (e.g., users an ad is presented to, time stamps, ad identifiers, device identifiers, wallet status of ads, etc).

The ad presentation module 210 can determine which ads of an ad collection to select for presentation on the user device (e.g., user device 204 and/or user device 206) in response to an ad request. For example, the ad presentation module 210 can identify and rank candidate ads from the ad collection based on particular criteria in order to match ads with requested content, the requesting API, and/or the requesting user.

The ad presentation module 210 can identify ads based on keywords associated with the ads in the collection that correspond with the requested content in which the ads are to be presented (e.g., matching ad keywords to keywords in requested content or query terms). In another example, the ad presentation module 210 uses information about a user (e.g., user profile information) to identify ads. In yet another example, the ad presentation module 210 can send ads to an application based on the specific application requesting the ads (e.g., the ads are for products or services that appeal to a typical user of the particular application) or user interactions with the application. In some implementations, an auction system is used to determine which ad from candidate ads matching criteria for the content will be selected for presentation or to adjust scores for candidate ads.

In some implementations, user interactions are anonymized to obscure the user's identify. For example, received information from users (e.g., user interactions, location, device or user identifiers) can be aggregated or removed/obscure (e.g., replace user identifier with random identifier) so that individually identifying information is anonymized while still maintaining the attributes or characteristics associated with particular information (e.g., types of user actions). In some other implementations, the received information is anonymized (so that the originating user device or user device user is unidentifiable) at the user device before transmission to the system that analyzes the received inputs. In this way, the actions of individual users can be obscured or unobservable while still permitting analysis of user information.

An ad wallet manager 216 can store and serve ads associated with user accounts. User ad storage accounts 218 can include account information for each user and ads associated with users. In some implementations, user accounts are managed by another system (not shown), and user account identifiers (e.g., log in and password information, available services, contact information) are used to index ads stored in the user ad storage accounts 218.

A synchronizer 220 synchronizes ads stored by users to an ad wallet with the user account and allows the user to access stored ads on various user devices. The synchronizer 220 can synchronize ads in response to a user storing an ad, a user request for access to a user account, user initiation of an ad wallet application, or in response to particular criteria (e.g., timing or event based).

Either of the user devices 204 and 206 can be, for example, mobile devices, desktops, laptops, tablets, etc. The user devices 204 and 206 can include a browser application and/or other applications. The user devices 204 and 206 can display ads and can store ads to ad wallets 208 and 210, respectively. The ad wallets 208 and 210 can synchronize stored ads with other devices associated with the respective users using the synchronizer 220. Additionally, the ad wallets 208 and 210 can be used to allow a user to share an ad with another user.

In some implementations, the ad wallet is part of an application on a mobile device, desktop, or other computing device. For example, user device 204 can be a mobile device and user device 206 can be a desktop device. The user of a user device 204 can save ads displayed on the user device 204 to the ad wallet 208 (e.g., the user can interact with a received ad and save the ad to the ad wallet 208). Additionally, the user can interact with the ads in the ad wallet 208 through an interface (e.g., a mobile application interface, web interface, etc). The ad wallet manager 216 can perform a synchronization of the saved ads with the user account using the synchronizer 220.

The ad wallet 210 on the user device 206 can request content items from the ad system 202, including the items synchronized with the user account by the ad wallet manager 216 from the ad wallet 208. Alternatively, the ad system 202 can synchronize the ads in the user account with other associated user devices (e.g., ad wallet 210 on user device 206), for example by sending newly added ads from particular user devices to the ad wallets of other devices associated with the user (e.g., ad wallet 210). In some implementations, the synchronized ads are always available through the user account and not necessarily through a corresponding ad wallet application (e.g., though a web application interface to the user account).

Turning to one example use, a user can be shown an ad on a device that is not convenient for further interaction, save the ad to their ad wallet, and be shown the ad on another device convenient for further interaction. In this example, the user device 208 is a desktop computer that serves an ad containing a coupon code, in the form of a character string or bar code, for a local retailer. The ad can be saved to the ad wallet 208; synchronized with the user's account in the ad system 202; and replicated to the ad wallet 210 on the user device 206, which in this example is a mobile device. The user can then present the ad from the mobile device at a retail location for redemption.

In some implementations, the mobile device's location information indicates that the mobile device is near the location associated with the ad, and an alert can be generated by the user device 206 and presented to the user.

In some implementations, the retrieving an ad from the ad wallet (on the same or different device) as well as a conversion of the ad can be recorded by the ad system 202, for example, in the ad logs 212 and/or conversion logs 214.

In another example, a user can be shown an ad on a device and the ad can be stored and displayed later at a more convenient time or device for the user. In this example, the user device 208 is a mobile device that displays an ad in a browser or mobile application. The ad can be stored to the ad wallet 208, for example the user may wish to interact with the ad at a more convenient time or with the keyboard-video-mouse capabilities of a desktop device. The ad wallet 208 is periodically synchronized to the user account of the ad system 202.

Synchronization can be based, for example, on time, rules, or user driven. For example, saving an ad to the ad wallet 208 can trigger synchronization with the user ad storage account. Alternatively, opening an ad wallet can trigger synchronization. Finally, synchronization can occur according to a time schedule (e.g., every hour). Additionally, synchronization can occur according to rules defining particular events or synchronization criteria, for example, a number of ads saved to the ad wallet such that synchronization occurs in batches.

The saved ad can be routed to the ad wallet 210 on the user device 210, in this example representing a desktop computer (e.g., in response to a request from another device or periodically pushed to corresponding ad wallet applications on other user devices). The synchronized ad can be displayed and interacted with on either the user device 204 or the user device 206.

In some implementations, synchronization also removes ads from the user account and ad wallets according to particular criteria. For example, ads can expire after a specified amount to time in the ad wallet. In another example, ads can be removed after redemption from a particular user device.

In a third example, a first user can be shown an ad on a device and the ad can be shared with a second user identified by the first user. An ad can be displayed on the user device 204, which, in this example, is associated with the first user. The user, for example noticing that the ad may be related to a hobby the second user enjoys, can use the ad wallet 208 to send the ad to the second user, e.g., identified by the second user's user ID, e-mail address, or name. In some implementations, the receiving user controls whether or not ads are allowed to be shared with them or which specific users are allowed to share ads with them.

The share event can be added to the ad logs 212 and/or conversion logs 214, and the ad can be saved by the ad wallet manager 216 as associated with the second user's account information in the user ad storage accounts 218. The first user can be credit for the sharing event, for example with a discount for a future transaction, account credit, or other reward. The ad can be sent from the ad system 202 to the ad wallet 210, which in this example is associated with the second user. In some implementations, a notification is sent to the second user (e.g., email, SMS, etc) notifying the second user of the shared ad. Upon display and/or conversion of the ad, or other interaction, by the second user, the ad logs 212 and/or conversion logs 214 can be updated.

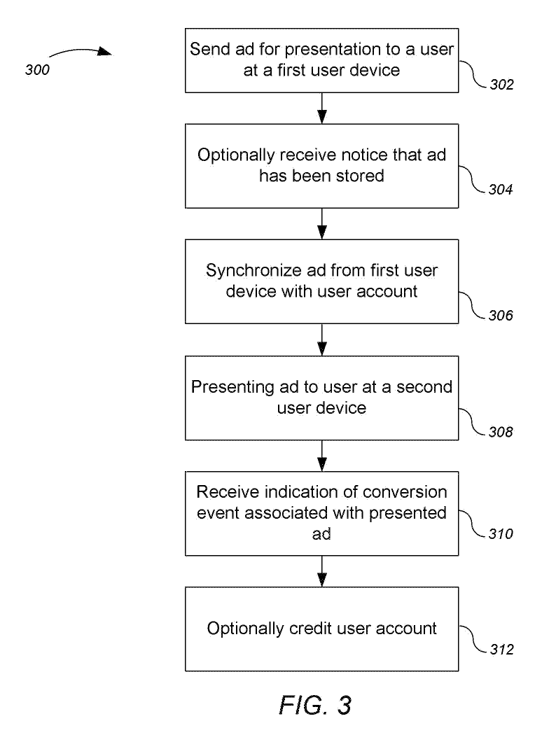

FIG. 3 is a flow diagram of an example process 300 for using an ad wallet. In some examples, the method 300 can be performed by a processor executing instructions in a computer readable storage medium. For example, the method 300 can be performed by an ad system (e.g., ad system 202).

An ad is sent (302) for presentation to a user of a first user device. The ad can be sent in response to a request by the user device, a user submitting a search query, as part of a web page loading in a browser, or for display in an application. The particular ad can be identified by the ad system (e.g., by an ad presentation manager) using various criteria such as keywords in a received ad request as described above with respect to FIGS. 1-2. The ad can be sent, for example, directly to the first user device or to a content provider for integration into content to be delivered to the user device.

A notice that the ad has been stored is optionally received (304). For example, the user of the first user device that presented the ad can save the displayed ad to an ad wallet, and as part of the saving the notice can be generated and sent to the ad system. The notice can include additional information, for example an ad identifier, a user identifier, a user location, or other information. In some implementations, the ad wallet is an application residing on the first user device. In some alternative implementations, the ad wallet is remotely located from the first user device.

The ad is synchronized (306) from the first user device with a user account. The ad identifier, or a copy of the ad, can be associated with the user account and stored (e.g., in an ad storage associated with the user account that stores all ads saved by the user to an ad wallet associated with the user). In some implementations, an ad log is updated with the storage event.

In some implementations, the ad is synchronized in response to the received notice from the first user device that the ad was stored. In some other implementations, the ad system requests information (e.g., periodically using a synchronizer) from user devices including the first user device for stored ads (e.g., ads stored since the last request).

In some implementations, the synchronization includes sending newly stored ads to other user devices associated with a user account. For example, the synchronizer can send the ad to ad wallets on other user devices in response to the storage of the ad on the first user device. Alternatively, the synchronization can be demand driven. For example, synchronization can occur when a user opens an ad wallet on a user device or can be manually initiated by a user from the ad wallet (e.g., as an option in a user interface of the ad wallet interface.

The ad is presented (308) to the user at a second user device. In particular, the user can access the ad wallet from the second user device, which when synchronized by the ad system includes the ad, which can be presented to the user upon selection. For example, the ad system can send the ad to the ad wallet of the second user device during synchronization. Alternatively, the ad system can send an identifier for the ad (e.g., name, thumbnail). When the user selects the identifier, the ad is presented to the user by the ad system.

The user can use the second user device to access the synchronized user account to send, receive, and update ads stored by the user. In some implementations, the stored ad can be presented in response to a user request to retrieve the stored ad. Alternatively, the stored ad can be presented to the user in response to an ad request from the user's device for which the stored add meets the criteria of the request (e.g., keyword, location, format, etc). In some implementations, the ad is presented through direct interaction with the user account. For example, the user can access a user account using a browser application (e.g., using a user account web interface). The ad system can present the stored ads in the browser interface.

An indication of a conversion event associated with the presented ad is received (310). For example, a user can follow a link in the ad to a landing page, or the user can make a purchase with the ad. The conversion event, and any associated details such as user identification and ad identification, can be stored to a conversion log.

The user's account is optionally credited (312) for interaction with the ad wallet. Incentives such as redeemable points, discounts, or social network awards can be supplied to the user's account, for example to encourage use of the ad wallet.

Although a particular number, type, and order of steps are described here, it will be understood that alternative numbers, orders, and types are possible. For example, a notice that an ad has been stored can include the user identifier of another user, and the ad can be delivered to that user's device (e.g., for sharing the ad with other users). In some examples, a message can be created and sent to the user to remind them to use the ad, for example at a user selected time, when a user access the user account with a particular user device or when a user device is near a particular location.

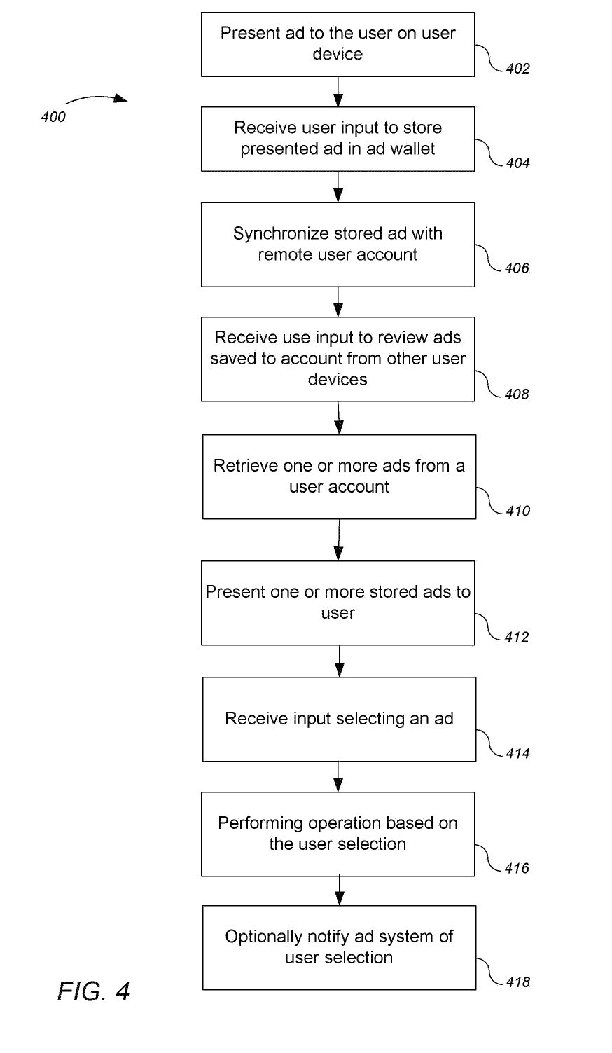

FIG. 4 is a flow diagram of an example process for using an ad wallet. In some examples, the method 400 can be performed by a processor executing instructions in a computer readable storage medium. For example, the method 400 can be performed by a user device (e.g., user device 204 and/or user device 206 of FIG. 2).

An ad is presented (402) to a user on a user device. In some implementations, the ad is presented with other content. For example, the ad can be displayed as part of a web page in a web browser, displayed by an application, or displayed by the operating system. The ad can include a title, detail text, still or moving image, and/or sound.

User input is received (404) to store the presented ad in an ad wallet. The ad, the displaying application, or the operating system of the device can include an interface element (e.g., a link, button, etc.) to receive user input directing the ad to be stored. The ad, ad identifier, user identifier, and/or other information can be stored to an ad wallet. For example, a user can right click on the presented ad. One or more menu options can be presented to the user including an option to store the ad in the ad wallet.

The stored ad is synchronized (406) with a remote user account. At regular intervals, or in response to an event, the ad and any other ads stored in the ad wallet can be sent to a remote ad server. Additionally, ads from the remote ad server and not stored in the ad wallet can be received and saved to the device's ad wallet, and any changes to ads on the remote ad server can be copied to the ads in the ad wallet.

User input is received (408) to review ads saved to the user account from other user devices. For example, the user can open an ad wallet application that provides an interface for presenting stored ads. Alternatively, a web interface can be used to access a user account at a remote location, for example, the remote user account.

One or more ads are retrieved (410) from a user account. The requested ads from the ad server can be received and saved to the device's ad wallet, or the device can display a user interface for the ad server that provides functionality to the user to interact with the requested ads. For example, ads saved by the user can be requested from the remote ad server, including ads saved by the user with other user devices for display by the ad wallet or can be locally stored in the ad wallet.

One or more of the stored ads are presented (412) to the user. The device can present the ads to the user from the user account in the ad wallet. In some implementations, a device's ad wallet can include ads associated with a plurality of users (e.g., different family members), and in some of these cases only the ads associated with a currently logged in user may be shown. In some other implementations, a list of ads in the ad wallet is initially presented. The user can then choose an ad from the list.

User input selecting a particular ad is received (414). The ad can be selected, for example, by clicking on the ad with an input device.

Operations are performed (416) based on the user selection. For example, the user can select an ad to perform a conversion (e.g., go to web page identified in the ad). The user can also share the ad with another user (e.g., by email or by sending to their wallet account). Also, the user can annotate ads for later use.

The ad system is optionally notified (418) of the user selection and or performed operations. The notification can include conversion details and can be used to credit the user's account for the interaction. Similarly, the notification can include the ad sharing which can then be logged and/or credited to the user. User annotations can also identify a conversion or other logging event based on the user's interaction with the ad as well as result in credit for the user.

Although a particular number, type, and order of steps are described here, it will be understood that alternative numbers, orders, and types are possible. For example, the user device can be configured to collect conversion events and transmit them in a batch, e.g., if network connectivity is unavailable or to reduce the usage of system resources.

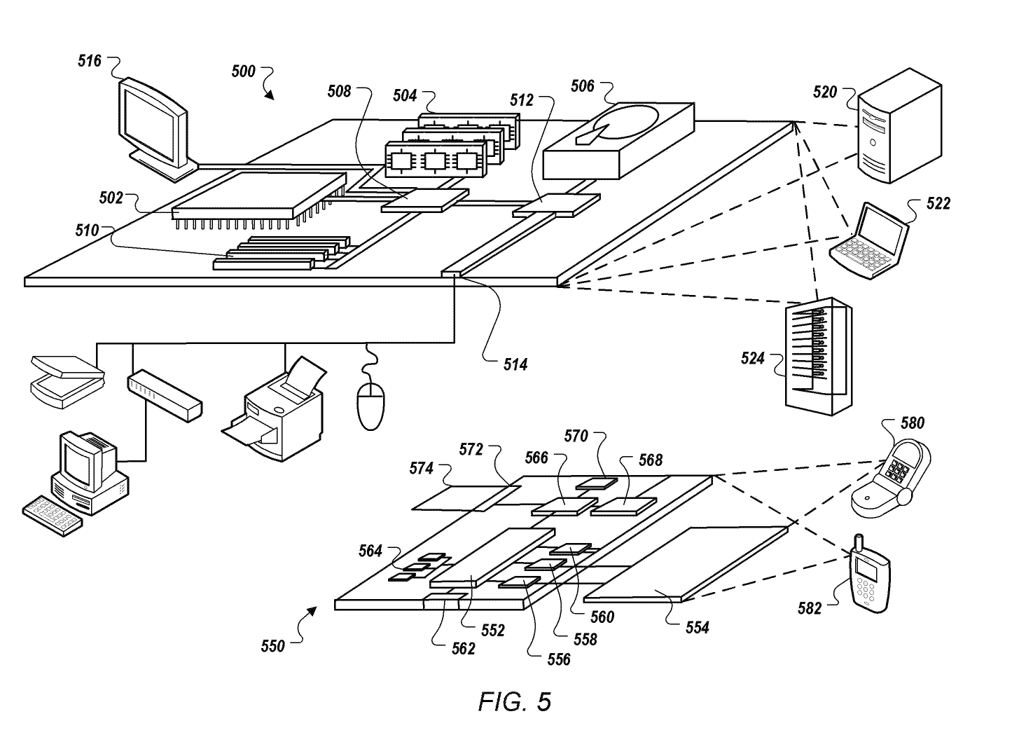

FIG. 5 shows an example of a computing device 500 and a mobile computing device 550. The computing device 500 and a mobile computing device 550 can be used to implement the techniques described herein the present specification. The computing device 500 is intended to represent various forms of digital computers, such as laptops, desktops, workstations, personal digital assistants, servers, blade servers, mainframes, and other appropriate computers. The mobile computing device is intended to represent various forms of mobile devices, such as personal digital assistants, cellular telephones, smart-phones, and other similar computing devices. The components shown here, their connections and relationships, and their functions, are meant to be exemplary only, and are not meant to limit implementations of the inventions described and/or claimed in this document.

The computing device 500 includes a processor 502, a memory 504, a storage device 506, a high-speed interface 508 connecting to the memory 504 and multiple high-speed expansion ports 510, and a low-speed interface 512 connecting to a low-speed expansion port 514 and the storage device 506. Each of the processor 502, the memory 504, the storage device 506, the high-speed interface 508, the high-speed expansion ports 510, and the low-speed interface 512, are interconnected using various busses, and can be mounted on a common motherboard or in other manners as appropriate. The processor 502 can process instructions for execution within the computing device 500, including instructions stored in the memory 504 or on the storage device 506 to display graphical information for a GUI on an external input/output device, such as a display 516 coupled to the high-speed interface 508. In other implementations, multiple processors and/or multiple buses can be used, as appropriate, along with multiple memories and types of memory. Also, multiple computing devices can be connected, with each device providing portions of the necessary operations (e.g., as a server bank, a group of blade servers, or a multi-processor system).

The memory 504 stores information within the computing device 500. In some implementations, the memory 504 is a volatile memory unit or units. In some implementations, the memory 504 is a non-volatile memory unit or units. The memory 504 can also be another form of computer-readable medium, such as a magnetic or optical disk.

The storage device 506 is capable of providing mass storage for the computing device 500. In some implementations, the storage device 506 can be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product can also contain instructions that, when executed, perform one or more methods, such as those described above. The computer program product can also be tangibly embodied in a computer- or machine-readable medium, such as the memory 504, the storage device 506, or memory on the processor 502.

The high-speed interface 508 manages bandwidth-intensive operations for the computing device 500, while the low-speed interface 512 manages lower bandwidth-intensive operations. Such allocation of functions is exemplary only. In some implementations, the high-speed interface 508 is coupled to the memory 504, the display 516 (e.g., through a graphics processor or accelerator), and to the high-speed expansion ports 510, which can accept various expansion cards (not shown). In the implementation, the low-speed interface 512 is coupled to the storage device 506 and the low-speed expansion port 514. The low-speed expansion port 514, which can include various communication ports (e.g., USB, Bluetooth, Ethernet, wireless Ethernet) can be coupled to one or more input/output devices, such as a keyboard, a pointing device, a scanner, or a networking device such as a switch or router, e.g., through a network adapter.

The computing device 500 can be implemented in a number of different forms, as shown in the figure. For example, it can be implemented as a standard server 520, or multiple times in a group of such servers. In addition, it can be implemented in a personal computer such as a laptop computer 522. It can also be implemented as part of a rack server system 524. Alternatively, components from the computing device 500 can be combined with other components in a mobile device (not shown), such as a mobile computing device 550. Each of such devices can contain one or more of the computing device 500 and the mobile computing device 550, and an entire system can be made up of multiple computing devices communicating with each other.

The mobile computing device 550 includes a processor 552, a memory 564, an input/output device such as a display 554, a communication interface 566, and a transceiver 568, among other components. The mobile computing device 550 can also be provided with a storage device, such as a micro-drive or other device, to provide additional storage. Each of the processor 552, the memory 564, the display 554, the communication interface 566, and the transceiver 568, are interconnected using various buses, and several of the components can be mounted on a common motherboard or in other manners as appropriate.

The processor 552 can execute instructions within the mobile computing device 550, including instructions stored in the memory 564. The processor 552 can be implemented as a chipset of chips that include separate and multiple analog and digital processors. The processor 552 can provide, for example, for coordination of the other components of the mobile computing device 550, such as control of user interfaces, applications run by the mobile computing device 550, and wireless communication by the mobile computing device 550.

The processor 552 can communicate with a user through a control interface 558 and a display interface 556 coupled to the display 554. The display 554 can be, for example, a TFT (Thin-Film-Transistor Liquid Crystal Display) display or an OLED (Organic Light Emitting Diode) display, or other appropriate display technology. The display interface 556 can comprise appropriate circuitry for driving the display 554 to present graphical and other information to a user. The control interface 558 can receive commands from a user and convert them for submission to the processor 552. In addition, an external interface 562 can provide communication with the processor 552, so as to enable near area communication of the mobile computing device 550 with other devices. The external interface 562 can provide, for example, for wired communication in some implementations, or for wireless communication in other implementations, and multiple interfaces can also be used.

The memory 564 stores information within the mobile computing device 550. The memory 564 can be implemented as one or more of a computer-readable medium or media, a volatile memory unit or units, or a non-volatile memory unit or units. An expansion memory 574 can also be provided and connected to the mobile computing device 550 through an expansion interface 572, which can include, for example, a SIMM (Single In Line Memory Module) card interface. The expansion memory 574 can provide extra storage space for the mobile computing device 550, or can also store applications or other information for the mobile computing device 550. Specifically, the expansion memory 574 can include instructions to carry out or supplement the processes described above, and can include secure information also. Thus, for example, the expansion memory 574 can be provided as a security module for the mobile computing device 550, and can be programmed with instructions that permit secure use of the mobile computing device 550. In addition, secure applications can be provided via the SIMM cards, along with additional information, such as placing identifying information on the SIMM card in a non-hackable manner.

The memory can include, for example, flash memory and/or NVRAM memory (non-volatile random access memory), as discussed below. In some implementations, a computer program product is tangibly embodied in an information carrier. The computer program product contains instructions that, when executed, perform one or more methods, such as those described above. The computer program product can be a computer- or machine-readable medium, such as the memory 564, the expansion memory 574, or memory on the processor 552. In some implementations, the computer program product can be received in a propagated signal, for example, over the transceiver 568 or the external interface 562.

The mobile computing device 550 can communicate wirelessly through the communication interface 566, which can include digital signal processing circuitry where necessary. The communication interface 566 can provide for communications under various modes or protocols, such as GSM voice calls (Global System for Mobile communications), SMS (Short Message Service), EMS (Enhanced Messaging Service), or MMS messaging (Multimedia Messaging Service), CDMA (code division multiple access), TDMA (time division multiple access), PDC (Personal Digital Cellular), WCDMA (Wideband Code Division Multiple Access), CDMA2000, or GPRS (General Packet Radio Service), among others. Such communication can occur, for example, through the transceiver 568 using a radio-frequency. In addition, short-range communication can occur, such as using a Bluetooth, WiFi, or other such transceiver (not shown). In addition, a GPS (Global Positioning System) receiver module 570 can provide additional navigation- and location-related wireless data to the mobile computing device 550, which can be used as appropriate by applications running on the mobile computing device 550.

The mobile computing device 550 can also communicate audibly using an audio codec 560, which can receive spoken information from a user and convert it to usable digital information. The audio codec 560 can likewise generate audible sound for a user, such as through a speaker, e.g., in a handset of the mobile computing device 550. Such sound can include sound from voice telephone calls, can include recorded sound (e.g., voice messages, music files, etc.) and can also include sound generated by applications operating on the mobile computing device 550.

The mobile computing device 550 can be implemented in a number of different forms, as shown in the figure. For example, it can be implemented as a cellular telephone 580. It can also be implemented as part of a smart-phone 582, personal digital assistant, or other similar mobile device.

Embodiments of the subject matter and the operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer programs, i.e., one or more modules of computer program instructions, encoded on a computer storage media for execution by, or to control the operation of, data processing apparatus. Alternatively or in addition, the program instructions can be encoded on an artificially generated propagated signal, e.g., a machine-generated electrical, optical, or electromagnetic signal, that is generated to encode information for transmission to suitable receiver apparatus for execution by a data processing apparatus. The computer storage medium can be, or be included in, a computer-readable storage device, a computer-readable storage substrate, a random or serial access memory array or device, or a combination of one or more of them.

The operations described in this specification can be implemented as operations performed by a data processing apparatus on data stored on one or more computer-readable storage devices or received from other sources.

The term “data processing apparatus” encompasses all kinds of apparatus, devices, and machines for processing data, including by way of example a programmable processor, a computer, a system on a chip, or combinations of them. The apparatus can include special purpose logic circuitry, e.g., an FPGA (field programmable gate array) or an ASIC (application specific integrated circuit). The apparatus can also include, in addition to hardware, code that creates an execution environment for the computer program in question, e.g., code that constitutes processor firmware, a protocol stack, a database management system, an operating system, a cross-platform runtime environment, e.g., a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing or executing instructions and one or more memory devices for storing instructions and data. Generally, a computer will also include, or be operatively coupled to receive data from or transfer data to, or both, one or more mass storage devices for storing data (e.g., magnetic, magneto optical disks, or optical disks). However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits data (e.g., an HTML page) to a client device (e.g., for purposes of displaying data to and receiving user input from a user interacting with the client device). Data generated at the client device (e.g., a result of the user interaction) can be received from the client device at the server.

While this specification contains many specific implementation details, these should not be construed as limitations on the scope of the invention or of what may be claimed, but rather as descriptions of features specific to particular embodiments of the invention. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the invention have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. A method comprising:
presenting a first content item to a first device associated with a user;
receive a input from the first device indicating that the first content item has been stored in a repository of the first device;
in response to the input, synchronizing the repository of the first device with a user account including the first content item;
receiving a request for one or more content items stored in the user account from a second device associated with the user;
presenting the requested content items on the second device associated with the user including the first content item;
receiving an indication of a conversion event associated with the presented first content item on the second device; and
logging the conversion event.

2. The method of claim 1, where the first content item is an advertisement.

3. The method of claim 1, further comprising:
crediting an account associated with the user in response to the conversion event.

4. The method of claim 3, where crediting includes awarding points that can be redeemed for one or more products or services.

5. The method of claim 3, where crediting includes providing one or more discounts.

6. The method of claim 1, further comprising:
providing interaction between the user of the second device and the contents of the user account including presenting a user interface for viewing content items synchronized to the user account.

7. The method of claim 1, where presenting the requested content items includes presenting redemption location information associated with each presented content item.

8. The method of claim 1, further comprising:
receiving a user request that a content item stored on the user device be shared with a second user; and
sending the content item to an account of the second user.

9. A system comprising:
one or more processors configured to interact with a computer storage medium in order to perform operations comprising:
presenting a first content item to a first device associated with a user;
receive a input from the first device indicating that the first content item has been stored in a repository of the first device;
in response to the input, synchronizing the repository of the first device with a user account including the first content item;
receiving a request for one or more content items stored in the user account from a second device associated with the user;
presenting the requested content items on the second device associated with the user including the first content item;
receiving an indication of a conversion event associated with the presented first content item on the second device; and
logging the conversion event.

10. The system of claim 9, where the first content item is an advertisement.

11. The system of claim 9, further configured to perform operations comprising:
crediting an account associated with the user in response to the conversion event.

12. The system of claim 11, where crediting includes awarding points that can be redeemed for one or more products or services.

13. The system of claim 11, where crediting includes providing one or more discounts.

14. The system of claim 9, further configured to perform operations comprising:
providing interaction between the user of the second device and the contents of the user account including presenting a user interface for viewing content items synchronized to the user account.

15. The system of claim 9, where presenting the requested content items includes presenting redemption location information associated with each presented content item.

16. The system of claim 9, further configured to perform operations comprising:
receiving a user request that a content item stored on the user device be shared with a second user; and
sending the content item to an account of the second user.

17. A computer storage medium encoded with a computer program, the program comprising instructions that when executed by data processing apparatus cause the data processing apparatus to perform operations comprising:
presenting a first content item to a first device associated with a user;
receive a input from the first device indicating that the first content item has been stored in a repository of the first device;
in response to the input, synchronizing the repository of the first device with a user account including the first content item;
receiving a request for one or more content items stored in the user account from a second device associated with the user;
presenting the requested content items on the second device associated with the user including the first content item;
receiving an indication of a conversion event associated with the presented first content item on the second device; and
logging the conversion event.

18. The computer storage medium of claim 17, where the first content item is an advertisement.

19. The computer storage medium of claim 17, further comprising:
crediting an account associated with the user in response to the conversion event.

20. The computer storage medium of claim 19, where crediting includes awarding points that can be redeemed for one or more products or services.

21. The computer storage medium of claim 19, where crediting includes providing one or more discounts.

22. The computer storage medium of claim 17, further comprising:
providing interaction between the user of the second device and the contents of the user account including presenting a user interface for viewing content items synchronized to the user account.

23. The computer storage medium of claim 17, where presenting the requested content items includes presenting redemption location information associated with each presented content item.

24. The computer storage medium of claim 17, further comprising:
receiving a user request that a content item stored on the user device be shared with a second user; and
sending the content item to an account of the second user.
